(19) United States
(12) Patent Application Publication
(10) Pub. No.: US 2016/0194970 A1
(43) Pub. Date: Jul. 7, 2016

(54) ARRANGEMENT FOR SECURING TURBINE BLADES

(71) Applicant: SIEMENS AKTIENGESELLSCHAFT, München (DE)

(72) Inventors: STEFAN BENTELE, MÜLHEIM AN DER RUHR (DE); ULRICH BEUL, ESSEN (DE); FRANK BRUMBI, MÜLHEIM AN DER RUHR (DE); OLIVER CERANSKI, MÜLHEIM (DE); MANUEL ETTLER, NÖRVENICH-WISSERSHEIM (DE); THOMAS HELMIS, MÜLHEIM AN DER RUHR (DE); MARKUS HOFMANN, CASTROP-RAUXEL (DE); DANIEL LINDEMANN, MÜLHEIM AN DER RUHR (DE); ADAM MAGUIRE, OBERHAUSEN (DE); OLIVER RICKEN, ESSEN (DE); ANDREAS STIEHM, REMAGEN-KRIPP (DE)

(21) Appl. No.: 14/915,686

(22) PCT Filed: Aug. 29, 2014
(86) PCT No.: PCT/EP2014/068354

§ 371 Date: Mar. 1, 2016

(30) Foreign Application Priority Data
Sep. 24, 2013 (EP) 13185739.3

(51) Int. Cl. F01D 9/04; F01D 25/24

(52) U.S. Cl. CPC F01D 9/044; F01D 25/246; F05D 2220/31; F05D 2240/12; F05D 2230/23

(57) ABSTRACT

An arrangement for securing turbine blades in a groove of an inner housing of a steam turbine is provided. A caulking piece which is made of bi-metal is used between the base of the turbine guide blade and the groove. The component is designed as a casing, in particular as an inner casing of a steam turbine.

### CROSS-REFERENCE TO RELATED APPLICATIONS

This application claims priority to PCT Application No. PCT/EP2014/068354, having a filing date of Aug. 29, 2014, based off of EP Application No. 13185739.3 having a filing date of Sep. 24, 2013, the entire contents of which are hereby incorporated by reference.

### FIELD OF TECHNOLOGY

The following relates to an arrangement for securing turbine blades, wherein the turbine blades have a turbine blade root which is fitted into a slot in a component, wherein a caulking piece is arranged between the turbine blade root and the component.

### BACKGROUND

Steam turbines, as an embodiment of a turbomachine, comprise a relatively large number of turbine blades which are divided into rotor blades and guide vanes. Rotor blades are arranged on the rotor and guide vanes are arranged in the casing. The guide vanes have a blade root which is installed in a corresponding slot in the casing. Installation is generally carried out by hand, which means that a technician inserts the individual steam turbine guide vanes into the corresponding slots by hand with a suitable force. In addition, a caulking piece is caulked between the blade root and the slot in order to exert an immobilizing force. Some guide vanes have shrouds which are twisted with respect to the root.

Documents DE 32 36 021 A, EP 2 372 095 A, JP S61 129405A, WO 2013/017805A and WO 2012/156633A each disclose a turbine blade attachment.

The caulking piece is generally driven by means of hammer blows, which requires a lot of physical effort and results in the technician involved quickly becoming tired.

The following aims to provide a remedy here. The following has the object of specifying an arrangement which requires the use of less force.

### SUMMARY

An aspect relates to an arrangement for securing turbine blades, wherein the turbine blades have a turbine blade root which is fitted into a slot in a component, wherein a caulking piece is arranged between the turbine blade root and the component, wherein the caulking piece is a bimetal and the turbine blade is designed as a turbine guide vane.

It is thus proposed, according to embodiments of the invention, that the caulking pieces for securing the turbine blade be made of a bimetal. At installation temperature, the caulking pieces should be straight and should be slightly oversized by between 0.1 mm and 0.2 mm. This allows the turbine blades to be inserted over the caulking pieces with little physical effort. The slight oversize is sufficient to prestress or jam the blade and thus to immobilize it in its final position. According to embodiments of the invention, the temperature is necessarily raised during operation, which leads to the bimetal bending in the direction of the turbine blade root. This means that a force is exerted by the bimetal on the turbine blade root and the slot, leading to immobilization.

This requires no structural modifications to be undertaken. Caulking pieces used hitherto can be replaced with caulking pieces made of bimetal. This would reduce the physical demands on technicians, which would also result in a reduction in the accident risk. In all, this reduces the force required to push the turbine blade over the caulking piece.

Furthermore, the simplified installation reduces costs since more turbine blades can be installed in the same time.

### BRIEF DESCRIPTION

Some of the embodiments will be described in detail, with reference to the following figures, wherein like designations denote like members, wherein:

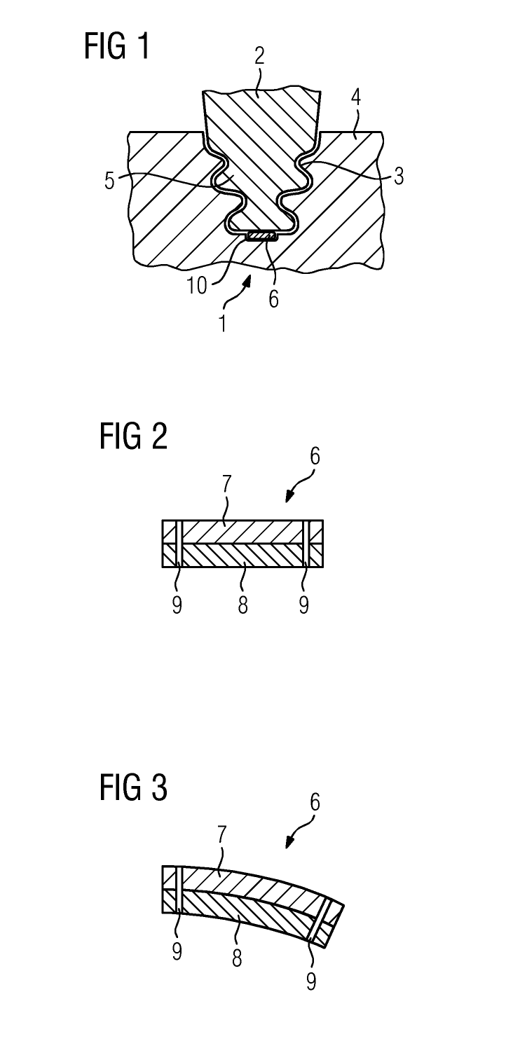

FIG. 1 shows a schematic representation of a turbine blade root in a component;

FIG. 2 shows a bimetallic caulking piece at installation temperature;

FIG. 3 shows a bimetallic caulking piece at operating temperature;

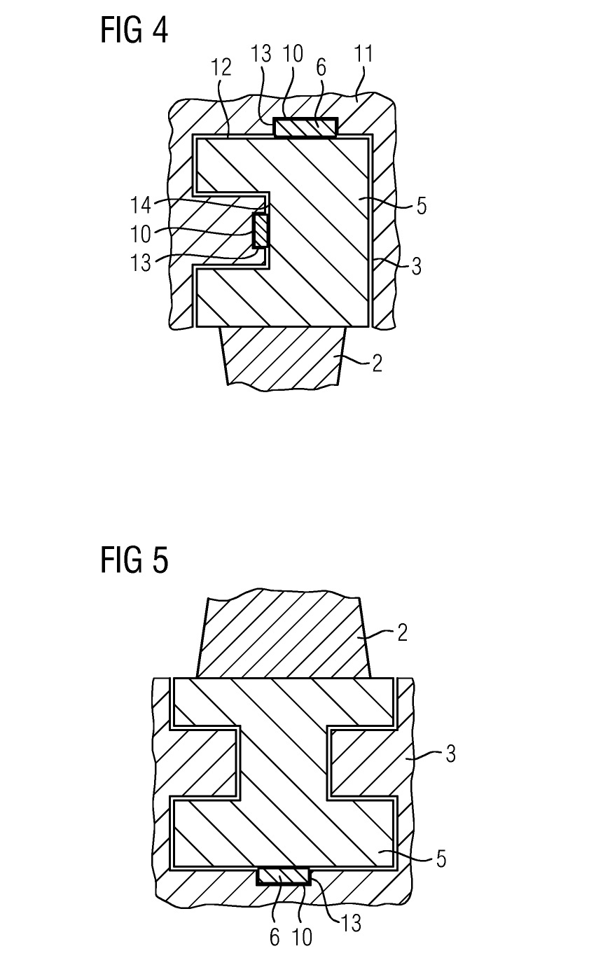

FIG. 4 shows a schematic representation of a turbine guide vane root; and

FIG. 5 shows a schematic representation of a turbine guide vane root with a T-root shape.

### DETAILED DESCRIPTION

FIG. 1 shows an arrangement for securing turbine blades 2 in a slot 3 of a component 4. The turbine blade 2 has a turbine blade root 5 which is fitted into the corresponding slot 3. A caulking piece 6 is arranged between the turbine blade root 5 and the component 4, wherein the caulking piece 6 is a bimetal.

The turbine blade 2 is embodied as a turbine guide vane for a steam turbine. Equally, the turbine blade 2 could be embodied as a compressor blade for a gas turbine or a compressor.

The component 4 is embodied as a casing, in particular as an inner casing of a steam turbine.

FIG. 2 shows the caulking piece 6 at installation temperature. The caulking piece 6 comprises a first material 7 and a second material 8, which are securely connected to one another by means of rigid connections 9 at either end.

The thermal expansion behavior of the first material 7 is different to that of the second material 8. Thus, the geometrical shape of the caulking piece 6 changes as the temperature rises; this is shown in FIG. 3. The caulking piece 6 exhibits curvature in one direction. Since the caulking piece 6 is arranged in a gap 10 between the turbine blade root 5 and the slot 3 while at installation temperature, a rise in temperature during operation causes an increase in the forces between the turbine blade root 5 and the slot 3, which improves the immobilization of the turbine blade 2.

The example shown here represents a turbine blade for use in a steam turbine. Equally possible is an application for compressor blades in gas turbines.

Embodiments of the invention can also be used for turbine guide vanes; this is shown in FIG. 4. The turbine guide vane shown in FIG. 4 has a turbine blade root 5 in the form of a hook root. This root has a surface 12 oriented toward a guide vane support 11. A gap 13 is formed in the guide vane support 11, and the caulking piece 6 is arranged in this gap.

Furthermore, the turbine blade root 5 has an essentially laterally arranged side face 14, which is oriented essentially perpendicular to the surface 12. The caulking piece 6 is arranged in a laterally arranged gap 13, which results in additional immobilization.

FIG. 5 shows a turbine blade root 5 in the form of a T-root.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An arrangement for securing turbine blades, wherein the turbine blades have a turbine blade root
which is fitted into a slot in a component, wherein a caulking piece is arranged between the turbine blade root and the component,
wherein the turbine blade is designed as a turbine guide vane,
wherein
the caulking piece is a bimetal.

2. The arrangement as claimed in claim 1, wherein the component is an inner casing of a steam turbine.
